(19) United States
(12) Patent Application Publication
(10) Pub. No.: US 2004/0068547 A1
(43) Pub. Date: Apr. 8, 2004

(54) Method for processing moving image/contents overlay, electronic mail processing method using the same, and computer-readable storage medium for storing program for execution of either of them

(76) Inventor: Yong-Hee Kang, Seoul (KR)

Correspondence Address: CANTOR COLBURN, LLP, 55 GRIFFIN ROAD SOUTH, BLOOMFIELD, CT, 06002

(21) Appl. No.: 10/470,887

(22) PCT Filed: Feb. 6, 2002
(86) PCT No.: PCT/KR02/00169

(30) Foreign Application Priority Data
Feb. 6, 2001 (KR) 2001-5679

(51) Int. Cl. G06F 15/16; G06F 17/60

(52) U.S. Cl. 709/206; 705/14; 709/246

(57) ABSTRACT

A method for processing a moving image/contents overlay, an electronic mail processing method using the same, and a computer-readable storage medium for storing a program for execution of either of them. Without synthesizing contents with a moving image, a service provider server sends separately to a computer of a user or an electronic mail server a compressed moving image, and a script including contents data information and edit information from the user, such that the user computer or an electronic mail recipient computer overlays the contents on the moving image at positions desired by the user and in forms desired by the user. As a result, the contents can be prevented from being distorted due to losses resulting from encoding and decoding processes. An electronic mail message can be naturally overlaid on the moving image.

### TECHNICAL FIELD

The present invention relates to a method for processing a moving image/contents overlay, an electronic mail (E-mail) processing method using the same, and a computer-readable storage medium for storing a program for execution of either of them, and more particularly to a moving image/contents overlay processing method wherein a service provider appends contents, such as a caption, to a moving image (i.e., a video image) stored in a database server or at least one of moving images that are shot in real time by a plurality of Web cameras, temporarily stored in a temporary storage unit and then provided in real time over a network, and provides the contents-appended moving image in an on-demand manner, and a video E-mail processing method for transmitting and receiving video mails using the same.

### BACKGROUND ART

In a conventional on-demand video processing method, if a user gains access to a server of a service provider over the Internet and requests it to send a desired moving image, such as a movie or music video, stored in a database server or a desired one of moving images that are shot in real time by a plurality of Web cameras, temporarily stored in a temporary storage unit and then provided in real time over a network, then the service provider server encodes the desired moving image and sends the resulting moving image data to the user.

Thereafter, the user receives the compressed moving image data sent from the service provider server in a streaming or downloading manner and views it through a media player run in his/her computer. The media player decodes the compressed moving image data sent from the service provider server to restore the original moving image, and displays the restored moving image to the user.

On the other hand, for provision of contents, such as a caption, to the user in addition to the above video provision service, the contents are conventionally mixed with moving image data, as shown in FIG. 1.

FIG. 1 is a block diagram of a conventional streaming-based moving image/contents overlay processing method. A server of a service provider edits an original moving image stream file to create a contents (for example, a caption) overlaid moving image file. The server then encodes the created contents-overlaid moving image file and sends the resulting moving image file to a user. Thereafter, the user receives the moving image file sent from the server over the Internet and decodes and displays it through a media player.

In the above-mentioned conventional streaming-based moving image/contents overlay processing method, the server creates a contents (for example, a caption)-overlaid moving image file by overlaying contents on an original moving image file, and encodes and sends the created contents-overlaid moving image file, and the user decodes and displays the moving image file sent from the server. However, the conventional overlay processing method has a disadvantage in that the contents, such as a caption, are distorted due to losses resulting from the encoding and decoding processes. Unfortunately, a severe distortion of the contents makes it hard to read the contents.

The conventional streaming-based moving image/contents overlay processing method has another disadvantage in that the service provider server edits the original moving image file in advance, resulting in there being no room for the user to edit the original moving image file at his/her discretion.

On the other hand, many video E-mail services have been provided to provide E-mails attached with moving images to recipients such that the moving images are reproduced in a streaming manner. Such video E-mail services are adapted to provide messages separately from the moving images. In this regard, no E-mail services providing message-overlaid moving images have been provided up to the present.

### DISCLOSURE OF THE INVENTION

Therefore, the present invention has been made in view of the above problems, and it is an object of the present invention to provide a moving image/contents overlay processing method for processing contents, such as a hypertextable character, banner advertisement, photograph, audio, scent, etc., on a moving image separately from the moving image, so that a user can edit the entire contents at his/her discretion.

It is another object of the present invention to provide an electronic mail processing method using a moving image/contents overlay processing method which processes contents, such as a hypertextable character, banner advertisement, photograph, audio, scent, etc., on a moving image separately from the moving image, so that a user can edit the entire contents at his/her discretion.

In accordance with one aspect of the present invention, the above and other objects can be accomplished by the provision of a method for processing a moving image/contents overlay in a video processing method which is executable in a video service provision computer connected to at least one user computer over the Internet, the moving image/contents overlay processing method comprising the steps of a) selecting any one of a plurality of given moving images; b) selecting one or more contents to be overlaid on the selected moving image; c) generating edit information associated with an overlay of the selected contents on the selected moving image; d) creating a script containing the generated edit information and contents data information; and e) sending moving image data obtained by encoding the selected moving image, and the created script to the user computer.

In accordance with another aspect of the present invention, there is provided a method for processing a moving image/contents overlay in a moving image reproducing method which is executable in a user computer connected to at least one video service provision computer over the Internet, the moving image/contents overlay processing method comprising the steps of a) receiving encoded moving image data and a script sent from the video service provision computer; b) decoding the received, encoded moving image data to restore an original moving image, and synthesizing contents with the restored moving image on the basis of edit information contained in the received script to overlay the contents on the moving image; and c) reproducing the contents-overlaid moving image.

Preferably, the edit information may include overlay position information, overlay form information, moving image/contents synthesis information and reproduction time information.

In accordance with another aspect of the present invention, in a video electronic mail processing method which is executable in a video service provision computer connected to at least one user computer over the Internet, there is provided a method for processing at least one electronic mail using a moving image/contents overlay processing method, comprising the steps of a) inputting an electronic mail address of an electronic mail recipient; b) selecting one of a plurality of given moving images; c) selecting one or more contents to be overlaid on the selected moving image; d) generating edit information associated with an overlay of the selected contents on the selected moving image; e) creating a script containing the generated edit information and contents data information; f) creating a mail message containing URL information indicative of locations of the script and moving image; and g) sending the created mail message to an electronic mail server of the electronic mail recipient.

In accordance with yet another aspect of the present invention, in a moving image reproducing method which is executable in a computer connected to at least one electronic mail server over the Internet, there is provided a method for processing at least one electronic mail using a moving image/contents overlay processing method, comprising the steps of a) receiving from the electronic mail server a mail message containing URL information indicative of locations of a script and a moving image; b) receiving encoded moving image data and the script on the basis of the URL information contained in the mail message; c) decoding the received, encoded moving image data to restore the moving image, and synthesizing contents with the moving image on the basis of edit information contained in the received script to overlay the contents on the moving image; and d) reproducing the contents-overlaid moving image.

Preferably, the edit information may include overlay position information, overlay form information, moving image/contents synthesis information and reproduction time information.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a conventional streaming-based moving image/contents overlay processing method;

FIG. 2 is a block diagram of a streaming-based moving image/contents overlay processing method in accordance with the present invention;

FIG. 3 is a flow chart illustrating the moving image/contents overlay processing method in accordance with the present invention;

FIG. 4 is a block diagram of a reproduction processor for the moving image/contents overlay processing method in accordance with the present invention;

FIG. 5 is a flow chart illustrating an electronic mail processing method using the moving image/contents overlay processing method in accordance with the present invention; and

FIGS. 6a to 6e are views illustrating examples of a moving image/contents overlay process in accordance with the present invention.

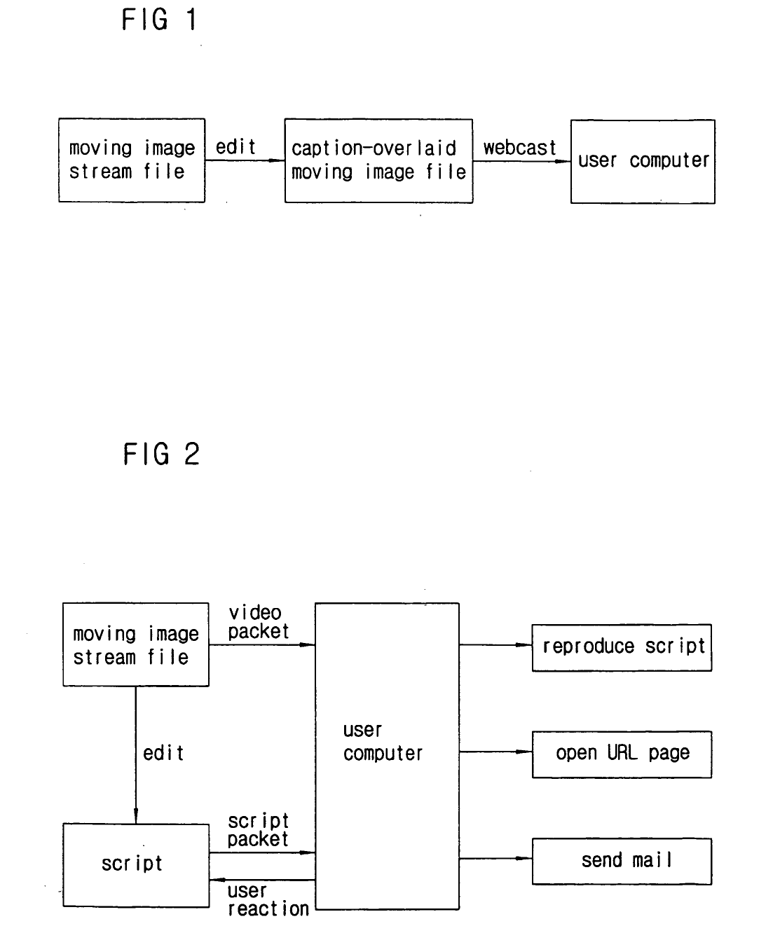

### BEST MODE FOR CARRYING OUT THE INVENTION

With reference to FIG. 2, there is shown in block form a streaming-based moving image/contents overlay processing method in accordance with the present invention.

The moving image/contents overlay processing method according to the present invention comprises a process by a server of a service provider and a process by a user.

In the server process, the service provider server inputs a moving image and contents selected by the Internet access user and generates edit information associated with an overlay of the contents on the moving image. Thereafter, the server encodes the moving image and Webcasts the resulting moving image data to a computer of the user in the form of a video packet. Further, the server creates a script containing the edit information and contents data information, and then Webcasts the created script to the user computer in the form of a script packet.

In the user process, the video packet Webcast from the service provider server is decoded into the original moving image by a video codec in the user computer. The script packet Webcast from the server is analyzed by a script parser, synthesized with the moving image by a synthesizer such that the contents are overlaid on the moving image, and then rendered for reproduction of the contents-overlaid moving image. If the user clicks a hypertext overlaid on the moving image, then a corresponding URL page is opened or an electronic mail (E-mail) is sent thereto.

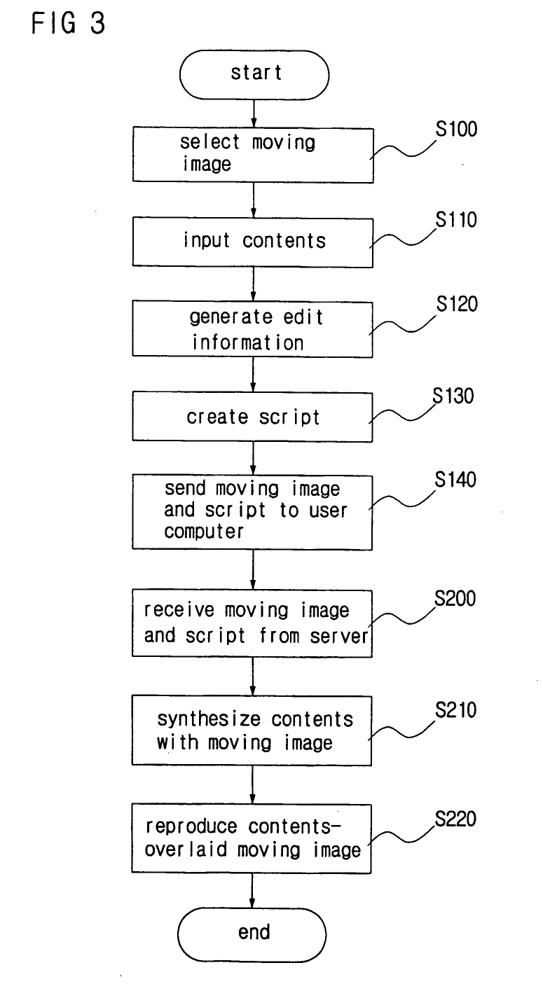

FIG. 3 is a flow chart illustrating the moving image/contents overlay processing method in accordance with the present invention.

As shown in FIG. 3, the moving image/contents overlay processing method according to the present invention comprises a server process including a selection step S100, a contents input step S110, an edit information generation step S120, a script creation step S130 and a sending step S140.

In detail, in the server process, the service provider server inputs any one of a plurality of given moving images, selected by the Internet access user, at the selection step S100. The server also inputs contents to be overlaid on the selected moving image, from the user, at the contents input step S110.

Note that the contents to be overlaid on the moving image include all materials displayable on a computer screen, such as a non-linkable character, a hypertextable character linked to an associated homepage, a banner advertisement, a graphic image such as a photograph or picture, an E-mail address, scent information and audio information.

At the edit information generation step S120, the server generates edit information associated with an overlay of the contents on the moving image. The edit information preferably contains information regarding positions of the moving image where the contents are to be overlaid, overlay form information, information regarding syntheses between the moving image and the contents, and reproduction time information. At the script creation step S130, the server creates a script containing the edit information generated at the above edit information generation step S120 and contents data information. At the sending step S140, the server sends moving image data obtained by encoding the moving image, and the script to the user computer.

The moving image/contents overlay processing method according to the present invention further comprises a user process including a reception step S200, a synthesis step S210 and a reproduction step S220.

In detail, in the user process, the Internet access user computer receives the encoded moving image data and the script sent from the service provider server at the reception step S200. At the synthesis step S210, the user computer decodes the encoded moving image data to restore the original moving image, and synthesizes the contents with the restored moving image on the basis of the edit information contained in the script to overlay the contents on the moving image. At the reproduction step S220, the user computer reproduces the contents-overlaid moving image synthesized at the above synthesis step S210.

As described above, the present moving image/contents overlay processing method is performed in a different manner from conventional moving image/contents overlay processing methods. Namely, in the present moving image/contents overlay processing method, without synthesizing contents with a moving image, the service provider server sends separately to the user computer a compressed moving image, and a script including contents data information and edit information, which contains overlay position information, overlay form information, moving image/contents synthesis information and reproduction time information, such that the user computer overlays the contents on the moving image. As a result, the contents can be prevented from being distorted due to losses resulting from encoding and decoding processes for the transfer of data. In other words, according to the present invention, the contents are not encoded and decoded for compression and decompression thereof, resulting in no data loss. Therefore, the contents with no distortion can be overlaid on the moving image.

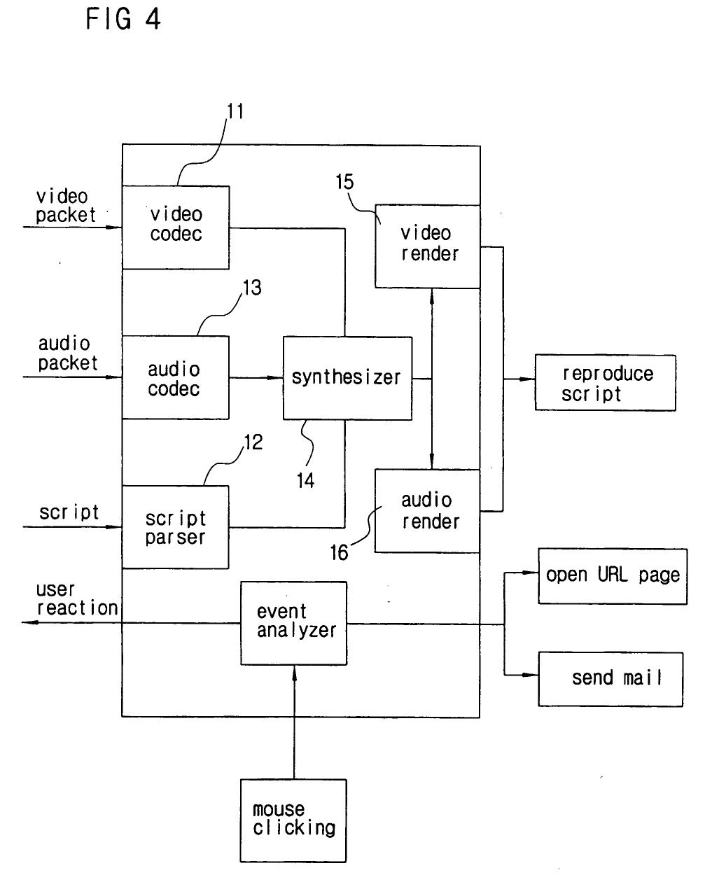

FIG. 4 is a block diagram of a reproduction processor for the moving image/contents overlay processing method in accordance with the present invention.

As shown in FIG. 4, the video packet Webcast from the service provider server is decoded and decompressed by a video codec 11. The script Webcast from the server is analyzed by a script parser 12. Video data decompressed by the video codec 11 and contents analyzed by the script parser 12 are synthesized by a synthesizer 14 and then reproduced in a streaming manner by a video render 15.

As a result, the contents are overlaid on the moving image being displayed. If the user clicks a hypertext among the contents overlaid on the moving image, then a corresponding URL page is opened or an E-mail is sent thereto. In the case where the user clicks a banner bar among the contents overlaid on the moving image, then an associated advertisement page is opened.

As shown in FIG. 4, the moving image/contents overlay processing method according to the present invention further comprises an audio process of decompressing audio data by an audio codec 13, synthesizing the decompressed audio data with the video data and contents by the synthesizer 14 and reproducing the resulting audio data by an audio render 16.

The audio data process is performed to compress and decompress audio data through the encoding and decoding steps in a similar manner to the video data process, and a detailed description thereof will thus be omitted.

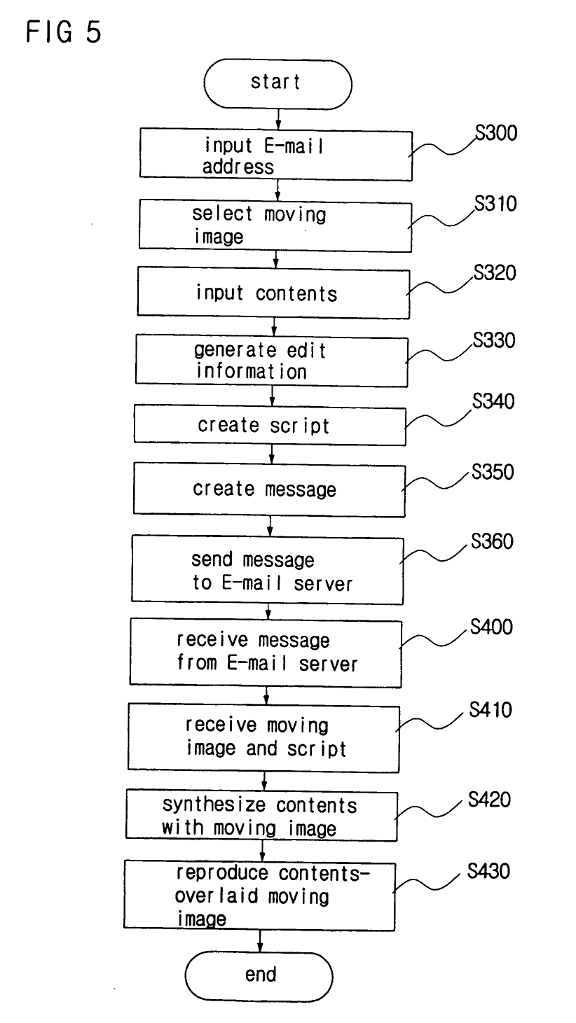

FIG. 5 is a flow chart illustrating an electronic mail processing method using the moving image/contents overlay processing method in accordance with the present invention.

The electronic mail processing method using the moving image/contents overlay processing method according to the present invention comprises an E-mail sending process performed by a server of a service provider, and an E-mail reception process performed by an E-mail recipient.

In the E-mail sending process, the service provider server inputs an address of the E-mail recipient entered by an Internet access user and a moving image and contents selected by the Internet access user and generates edit information associated with an overlay of the contents on the moving image. Thereafter, the service provider server encodes the moving image and sends the resulting moving image data to an E-mail server of the E-mail recipient in the form of a video packet. Further, the service provider server creates a script containing the edit information and contents data information, and then sends the created script to the E-mail server of the E-mail recipient in the form of a script packet.

In the E-mail reception process, a computer of the Email recipient receives the video packet from the E-mail server over the Internet and decodes it through a video codec to restore the original moving image. The script packet received from the E-mail server is analyzed by a script parser, synthesized with the moving image by a synthesizer such that the contents are overlaid on the moving image, and then rendered for reproduction of the contents-overlaid moving image. If the user clicks a hypertext overlaid on the moving image, then a corresponding URL page is opened or an E-mail is sent thereto.

In detail, the E-mail sending process includes an address input step S300, a selection step S310, a contents input step S320, an edit information generation step S330, a script creation step S340, a message creation step S350 and an E-mail sending step S360.

The service provider server inputs the address of the E-mail recipient entered by the Internet access user at the address input step S300. The server also inputs any one of a plurality of given moving images, selected by the Internet access user, at the selection step S310. The server further inputs contents to be overlaid on the selected moving image, from the user, at the contents input step S320.

At the edit information generation step S330, the service provider server generates edit information associated with an overlay of the contents on the moving image. The edit information preferably contains information regarding positions of the moving image where the contents are to be overlaid, overlay form information, information regarding syntheses between the moving image and the contents, and reproduction time information. At the script creation step S340, the server creates a script containing the edit information generated at the above edit information generation step S330 and contents data information. At the message creation step S350, the server creates a mail message containing URL information indicative of the locations of the script and moving image. Then, the service provider server sends the mail message to the E-mail server of the E-mail recipient at the E-mail sending step S360.

The E-mail reception process includes an E-mail reception step S400, a moving image/script reception step S410, a synthesis step S420 and a reproduction step S430.

The E-mail recipient computer receives from the E-mail server the mail message containing the URL information indicative of the locations of the script and moving image at the E-mail reception step S400. At the moving image/script reception step S410, the E-mail recipient computer receives the encoded moving image data and the script on the basis of the URL information contained in the mail message. At the synthesis step S420, the E-mail recipient computer decodes the encoded moving image data and synthesizes the contents with the resulting moving image on the basis of the edit information contained in the script to overlay the contents on the moving image. At the reproduction step S430, the E-mail recipient computer reproduces the contents-overlaid moving image synthesized at the above synthesis step S420.

As described above, the electronic mail processing method using the moving image/contents overlay processing method according to the present invention is performed in a different manner from conventional electronic mail processing methods. That is, in the present electronic mail processing method, without synthesizing contents with a moving image, the service provider server sends separately to the E-mail recipient computer a compressed moving image, and a script including contents data information and edit information, which contains overlay position information, overlay form information, moving image/contents synthesis information and reproduction time information, such that the E-mail recipient computer overlays the contents on the moving image. As a result, the contents can be prevented from being distorted due to losses resulting from encoding and decoding processes for the transfer of data. Further, for sending of an E-mail, a mail message can be overlaid as content on a moving image. Therefore, the E-mail recipient can receive a unique and high-grade mail message.

The present invention further provides a computer-readable storage medium for storing programs for execution of the moving image/contents overlay processing method and the electronic mail processing method using the same.

In the present invention, the storage medium is a typical storage unit such as a floppy disk, hard disk, CD-ROM or etc. The execution programs are installed or plugged in a computer through the storage medium to execute in the computer the moving image/contents overlay processing method and the electronic mail processing method using the same.

The process where the service provider server sends the encoded moving image and the script containing the edit information and contents data information to the user or Email recipient computer will hereinafter be described in more detail in conjunction with embodiments.

The URLs indicative of the locations of the moving image and script are two parameters in a plugin tag of a program executable in the computer.

If the user or E-mail recipient computer requests the video service from the service provider server, then the server sends the moving image and script from URL locations designated by the two parameters in the plugin tag to the user or E-mail recipient computer. Thereafter, the user or E-mail recipient computer receives and reproduces the moving image and script sent from the service provider server in a streaming or downloading manner.

<Embodiment 1>

The embodiment 1 is the case where the service provider server sends both the moving image and script to the user or E-mail recipient computer in the downloading manner.

In response to the video service request from the user or E-mail recipient computer, the service provider server sends the moving image and script from the corresponding URL locations to the user or E-mail recipient computer en masse with reference to the two parameters in the plugin tag.

After downloading the moving image and script sent from the service provider server, the user or E-mail recipient computer executes the moving image through a media player. At this time, the contents are overlaid on the corresponding positions of the moving image on the basis of the overlay position information, overlay form information, moving image/contents synthesis information and reproduction time information in the edit information, and the contents data information, contained in the script.

The contents to be overlaid on the moving image include all types of data formats supportable by the media player, such as a general character, a linkable hypertext character, an HTML text, an E-mail address, and a graphic image such as a picture or photograph.

<Embodiment 2>

The embodiment 2 is the case where the service provider server sends both the moving image and script to the user or E-mail recipient computer in the streaming manner.

In response to the video service request from the user or E-mail recipient computer, the service provider server sends the moving image and script from the corresponding URL locations to the user or E-mail recipient computer on a packet basis with reference to the two parameters in the plugin tag.

The user or E-mail recipient computer receives the moving image and script sent from the service provider server packet-by-packet, and then executes the moving image through a media player. At this time, the contents are overlaid on the corresponding positions of the moving image being received packet-by-packet, on the basis of the overlay position information, overlay form information, moving image/contents synthesis information and reproduction time information in the edit information, and the contents data information, contained in the script.

<Embodiment 3>

The embodiment 3 is the case where the service provider server first sends the script to the user or E-mail recipient computer in the downloading manner and then the moving image to the computer in the streaming manner.

Upon receiving the video service request from the user or E-mail recipient computer, the service provider server first sends the script from the corresponding URL location to the user or E-mail recipient computer en masse with reference to the corresponding parameter in the plugin tag. The service provider server then sends the moving image from the corresponding URL location to the user or E-mail recipient computer on a packet basis with reference to the corresponding parameter in the plugin tag. Thereafter, the user or E-mail recipient computer receives the moving image sent from the service provider server packet-by-packet, and then displays the moving image through a media player therein. At this time, the contents are overlaid on the corresponding positions of the moving image being received packet-by-packet, on the basis of the overlay position information, overlay form information, moving image/contents synthesis information and reproduction time information in the edit information, and the contents data information, contained in the previously downloaded script.

<Embodiment 4>

The embodiment 4 is the case where the service provider server sends the moving image and script to the user or E-mail recipient computer in the streaming or downloading manner, and the user or E-mail recipient computer displays the contents-overlaid moving image through a media player therein, wherein the overlaid contents are moving images, too.

That is, in this embodiment, the script stored in the location of the script URL which is one of the two parameters in the plugin tag includes another plugin tag.

Accordingly, the user or E-mail recipient computer executes the moving image through the media player and, at this time, the moving image contents are overlaid on the corresponding positions of the moving image on the basis of the overlay position information, overlay form information, moving image/contents synthesis information and reproduction time information in the edit information, and the contents data information, contained in the script.

<Embodiment 5>

The embodiment 5 is the case where the contents include scent information under the condition that any one of the sending methods in the embodiments 1 to 4 is employed.

In this embodiment, the service provider server sends to the user or E-mail recipient computer the contents including scent information compatible with, for example, software SENXWare SDS (Scent Design Studio) by Trisenx, Inc., and the user or E-mail recipient computer reproduces the scent information through a dedicated scent generator cartridge therein.

Namely, if the user selects a scent appropriate to the moving image provided from the sender, the selected scent is emitted at a proper time.

<Embodiment 6>

The embodiment 6 is the case where the contents include audio information under the condition that any one of the sending methods in the embodiments 1 to 4 is employed.

In this embodiment, the service provider server sends to the user or E-mail recipient computer the contents including voice or music information selected or uploaded by the user at his/her discretion, and the user or E-mail recipient computer reproduces the voice or music information through a dedicated audio player therein.

<Embodiment 7>

The embodiment 7 is the case where the contents include a variety of materials, such as a hypertext, a graphic image, audio information, scent information, an HTML text, etc., under the condition that any one of the sending methods in the embodiments 1 to 4 is employed.

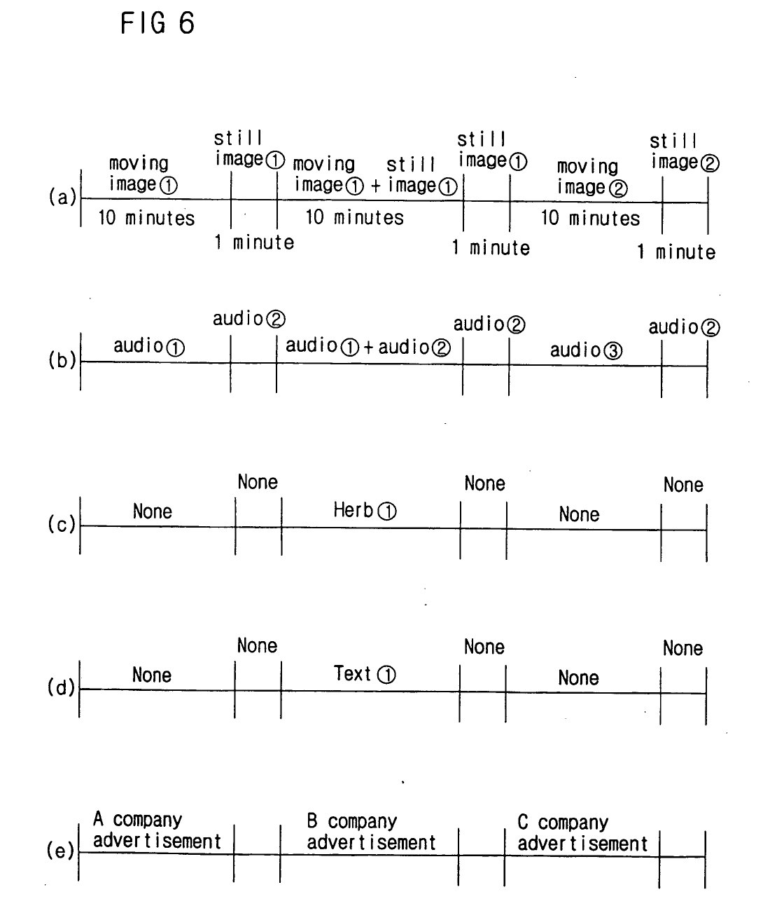

For example, in the case where the user intends to edit one moving image session for 33 minutes, the moving image session may be composed of a first moving image for 10 minutes, a first still image for 1 minute, the first still image on the first moving image for the next 10 minutes, the first still image for the next 1 minute, a second moving image for the next 10 minutes, and a second still image for the next 1 minute, as shown in FIG. 6a. At this time, the audio information may be composed of first audio for 10 minutes, second audio for 1 minute, a combination of the first audio and the second audio for the next 10 minutes, the second audio for the next 1 minute, third audio for the next 10 minutes, and the second audio for the next 1 minute, as shown in FIG. 6b. The scent information may be composed of a herb scent emitted only while the first still image is overlaid on the first moving image after 11 minutes, as shown in FIG. 6c. The text, which is the user's message, is displayed on a certain area while the herb scent is emitted, as shown in FIG. 6d. The hypertext is composed of different contents at different times, as shown in FIG. 6e. Provided that the hypertext is a banner advertisement, the service provider, not the user, may edit and insert the hypertext freely with no user's permission in compensation for the service provision. It will be understood that optimum advertisements (for example, an A company advertisement, B company advertisement and C company advertisement in order) may be previously programmed to be provided in such a situation that a viewer is interested in the entire one-session moving image edited by the user.

Although the text and still image can be simply displayed, various display positions or sizes may be applied thereto. It will also be understood that the text and still image may be subjected to a variety of effects such as scroll, marquee, transparent process, semitransparent process, screen separation and so forth.

The above embodiments have been disclosed to generate edit information associated with various types of contents under the control of the user. Alternatively, if there is no edit information input from the user, the service provider server itself may randomly generate and send edit information.

### INDUSTRIAL APPLICABILITY

As apparent from the above description, the present invention provides a moving image/contents overlay processing method wherein a service provider server sends a moving image and contents separately such that a user or Email recipient computer overlays the contents on the moving image, and an electronic mail processing method using the same. According to the present invention, the contents are not distorted, so that they can be distinct. Also, an E-mail message can be naturally overlaid on the moving image. Therefore, the user can freely transfer a unique and high-grade editable mail message. Further, contents such as audio or scent can be applied to a mail message, resulting in an increase in three-dimensional effect of message transfer. Furthermore, interactive contents can be overlaid on the moving image. As a result, in the case where the interactive contents are applied to moving image advertisements, advertising effects can be enhanced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for processing a moving image/contents overlay in a video processing method which is executable in a video service provision computer connected to at least one user computer over the Internet, said moving image/contents overlay processing method comprising the steps of:
a) selecting any one of a plurality of given moving images;
b) selecting one or more contents to be overlaid on the selected moving image;
c) generating edit information associated with an overlay of the selected contents on said selected moving image;
d) creating a script containing the generated edit information and contents data information; and
e) sending moving image data obtained by encoding said selected moving image, and the created script to said user computer.

2. A method for processing a moving image/contents overlay in a moving image reproducing method which is executable in a user computer connected to at least one video service provision computer over the Internet, said moving image/contents overlay processing method comprising the steps of:
a) receiving encoded moving image data and a script sent from said video service provision computer;
b) decoding the received, encoded moving image data to restore an original moving image, and synthesizing contents with the restored moving image on the basis of edit information contained in the received script to overlay the contents on said moving image; and
c) reproducing the contents-overlaid moving image.

3. The moving image/contents overlay processing method as set forth in claim 1 or 2, wherein said edit information includes overlay position information, overlay form information, moving image/contents synthesis information and reproduction time information.

4. The moving image/contents overlay processing method as set forth in claim 1 or 2, wherein said contents include a text or a hypertextable character linked to an associated homepage.

5. The moving image/contents overlay processing method as set forth in claim 1 or 2, wherein said contents include a banner advertisement.

6. The moving image/contents overlay processing method as set forth in claim 1 or 2, wherein said contents include a graphic image, said graphic image being a photograph or picture.

7. The moving image/contents overlay processing method as set forth in claim 1 or 2, wherein said contents include scent information.

8. The moving image/contents overlay processing method as set forth in claim 1 or 2, wherein said contents include audio information.

9. A computer-readable storage medium for storing a program for execution of the moving image/contents overlay processing method as set forth in claim 1 or 2.

10. In a video electronic mail processing method which is executable in a video service provision computer connected to at least one user computer over the Internet, a method for processing at least one electronic mail using a moving image/contents overlay processing method, comprising the steps of:
a) inputting an electronic mail address of an electronic mail recipient;
b) selecting one of a plurality of given moving images;
c) selecting one or more contents to be overlaid on the selected moving image;
d) generating edit information associated with an overlay of the selected contents on said selected moving image;
e) creating a script containing the generated edit information and contents data information;
f) creating a mail message containing URL information indicative of locations of said script and moving image; and
g) sending the created mail message to an electronic mail server of said electronic mail recipient.

11. In a moving image reproducing method which is executable in a computer connected to at least one electronic mail server over the Internet, a method for processing at least one electronic mail using a moving image/contents overlay processing method, comprising the steps of:
a) receiving from said electronic mail server a mail message containing URL information indicative of locations of a script and a moving image;
b) receiving encoded moving image data and the script on the basis of said URL information contained in said mail message;
c) decoding the received, encoded moving image data to restore said moving image, and synthesizing contents with said moving image on the basis of edit information contained in the received script to overlay the contents on said moving image; and
d) reproducing the contents-overlaid moving image.

12. The electronic mail processing method as set forth in claim 10 or 11, wherein said edit information includes overlay position information, overlay form information, moving image/contents synthesis information and reproduction time information.

13. The electronic mail processing method as set forth in claim 10 or 11, wherein said contents include a text or a hypertextable character linked to an associated homepage.

14. The electronic mail processing method as set forth in claim 10 or 11, wherein said contents include a banner advertisement.

15. The electronic mail processing method as set forth in claim 10 or 11, wherein said contents include a graphic image, said graphic image being a photograph or picture.

16. The electronic mail processing method as set forth in claim 10 or 11, wherein said contents include scent information.

17. The electronic mail processing method as set forth in claim 10 or 11, wherein said contents include audio information.

18. A computer-readable storage medium for storing a program for execution of the electronic mail processing method as set forth in claim 10 or 11.
